(19) United States
(12) Patent Application Publication
(10) Pub. No.: US 2021/0159470 A1
(43) Pub. Date: May 27, 2021

(54) BATTERIES WITH COMPOSITE HEADER CONSTRUCTION

(71) Applicant: Pacesetter, Inc., Sylmar, CA (US)

(72) Inventors: John Duggan, Greenville, SC (US); Timothy R. Marshall, Pickens, SC (US); Steven Davis, Greer, SC (US)

(21) Appl. No.: 17/098,312

(22) Filed: Nov. 13, 2020

Related U.S. Application Data
(60) Provisional application No. 62/941,597, filed on Nov. 27, 2019.

(51) Int. Cl. H01M 2/06; H01M 2/08; H01M 2/30; H01M 2/26

(52) U.S. Cl. CPC H01M 2/06; H01M 2/26; H01M 2/30; H01M 2/08

(57) ABSTRACT

The battery has a header positioned in an opening in a case. An electrode is in the case and a terminal is in electrical communication with the electrode through the header. A cured epoxy contacts the case and the terminal such that the epoxy seals the opening in the case. The header is located between the electrodes and the epoxy. The header can exclude a glass-to-metal seal.

### RELATED APPLICATIONS

This application claims the benefit of U.S. Patent Application Ser. No. 62/941,597, filed Nov. 27, 2019, entitled “Batteries with Composite Header Construction,” and incorporated herein in its entirety.

### FIELD

The invention relates to electrochemical devices. In particular, the invention relates to batteries.

### BACKGROUND

Glass-to-metal seals are typically used to provide hermetic seals in implantable batteries. However, glass-to-metal seals are expensive and unreliable. As a result, there is a need for an improved battery construction that is suitable for use in applications including implantable applications such as active implantable medical devices.

### SUMMARY

A battery has a header positioned at an opening in a case. An electrode is in the case and a terminal is in electrical communication with the electrode through the header. A cured epoxy contacts the case and the terminal such that the epoxy seals the opening in the case. The header is located between the electrodes and the epoxy. The header can exclude a glass-to-metal seal.

Another embodiment of a battery has a header at an opening in a case. The header includes a header support partially embedded in an insulating body. An electrode is positioned in the case. A terminal electrically communicates with the electrode along an electrical pathway that extends through the header support and through the insulating body.

Yet another embodiment of the battery includes a header at an opening in a case. A pin extends through the header such that a portion of the pin acts as a battery terminal. An electrode is positioned in the case and includes an active medium in contact with an electrode conductor. The electrode conductor includes a current collector and a seat. The seat includes at least three retainers that receive the pin such that a portion of the pin is positioned within the active medium.

### BRIEF DESCRIPTION OF THE FIGURES

FIG. 1 through FIG. 22 illustrate fabrication of a battery. FIG. 1 is a perspective view of a cathode conductor that includes a cathode tab and a cathode current collector.

FIG. 2 is a perspective view of the cathode conductor and cathode active media. FIG. 2 illustrates positioning of the cathode active media on the cathode current collector.

FIG. 3 is a perspective view of the cathode assembly that results from positioning the cathode active media on the cathode current collector as shown in FIG. 2.

FIG. 4 is a perspective view of the cathode assembly in FIG. 3 packed in a separator pouch.

FIG. 5 is a perspective view of an anode conductor that includes an anode tab and anode current collectors connected to a bridge.

FIG. 6 is a perspective view of the anode conductor of FIG. 5 after folding of the bridge and tab.

FIG. 7 is a perspective view of the anode conductor and anode active media. FIG. 7 illustrates positioning of the anode active media on the cathode current collectors.

FIG. 8 is a perspective view of the anode assembly that results from positioning the anode active media on the anode current collector as shown in FIG. 7 and folding the anode conductor at the bridge.

FIG. 9 illustrates a header support.

FIG. 10A through FIG. 10E illustrate a battery header that includes the header support of FIG. 9. FIG. 10A is perspective view of the header.

FIG. 10B is a top view of the header.

FIG. 10C is a cross section of the header taken along either of the lines labeled C in FIG. 10B.

FIG. 10D is a cross section of the header taken along either of the lines labeled D in FIG. 10B.

FIG. 10E is a cross section of the header taken along either of the lines labeled E in FIG. 10B.

FIG. 11 is a perspective view of a retainer that is suitable for use with a header constructed according to FIG. 10A through FIG. 10E.

FIG. 12 is a perspective view of the anode assembly being attached to the header.

FIG. 13 is a perspective view of the cathode assembly being attached to the header so as to form an electrode assembly that includes one or more anodes alternated with one or more cathodes.

FIG. 14 is a perspective view of the electrode assembly being positioned in an insulating boot and the boot being positioned in a battery case.

FIG. 15 and FIG. 16 are cross sections of the battery precursor that results from the assembly process shown in FIG. 14. FIG. 15 is a cross section of the battery precursor taken through the cathode tab.

FIG. 16 is a cross section of the battery precursor taken through the cathode tab and also through a portion of the anode tab.

FIG. 17 includes a perspective view of a terminal assembly. FIG. 17 also includes a cross section of the battery precursor and shows connection of the terminal assembly to a tab shown in the battery precursor.

FIG. 18 is a cross section of the battery precursor after connection of terminal assemblies to the tabs of the anode assembly and the cathode assembly in the battery precursor of FIG. 15 through FIG. 17.

FIG. 19 is a cross section of the battery precursor after a first case plug is positioned over the header in the battery precursor of FIG. 18.

FIG. 20 is a cross section of the battery precursor after a plug is positioned in a pathway through the header in the battery precursor of FIG. 19.

FIG. 21 is a cross section of the battery precursor after a second case plug is positioned over the first case plug in the battery precursor of FIG. 20.

FIG. 22 is a cross section of the battery precursor of FIG. 21 with a vapor barrier positioned in the second case plug.

FIG. 23 through FIG. 36 illustrate fabrication of another embodiment of the battery. FIG. 23 is a perspective view of a cathode conductor that includes a terminal seat and a cathode current collector extending outward from the perimeter of the terminal seat. The terminal seat includes retainers that extend between common supports.

FIG. 24A is a perspective view of the cathode conductor of FIG. 23 after insertion of a terminal pin into a channel that is at least partially defined by the retainers.

FIG. 24B is a perspective view of a portion of a pin.

FIG. 25 is a perspective view of a packaged cathode with a cathode assembly that includes the cathode conductor of FIG. 24A.

FIG. 26 is a perspective view of an anode conductor that includes anode current collectors connected to a bridge.

FIG. 27 is a perspective view of a pin connected to the bridge on the anode conductor of FIG. 26.

FIG. 28 is a perspective view of the anode assembly that results from positioning the anode active media on the anode current collector as shown in FIG. 27 and folding of the anode conductor at the bridge.

FIG. 29 is a perspective view of the cathode assembly and the anode assembly attached to the header so as to form an electrode assembly that includes one or more anodes alternated with one or more cathodes.

FIG. 30 and FIG. 31 are cross sections of the battery precursor that results from the assembly process disclosed in the context of FIG. 23 through FIG. 29. FIG. 30 is a cross section of the battery precursor taken through the pin from the cathode assembly.

FIG. 31 is a cross section of the battery precursor taken through the pin from the cathode assembly and the pin from the anode assembly. The cross section of FIG. 31 can be perpendicular to the cross section of FIG. 30.

FIG. 32 is a cross section of the battery precursor after a first case plug is positioned over the header in the battery precursor of FIG. 31 and a plug is inserted in a pathway though the header.

FIG. 33 is a cross section of the battery precursor after a second case plug is positioned over the first case plug in the battery precursor of FIG. 32.

FIG. 34 is a cross section of an example of a battery.

FIG. 35 is a cross section of another example of a battery.

FIG. 36 is a schematic diagram of a defibrillation system as one example of an active implantable medical device that has the battery included as part of or within an Implantable Cardioverter Defibrillator (ICD)

### DESCRIPTION

One embodiment of a battery has a header positioned at an opening in a case. An electrode assembly is positioned in the case and one or more terminals are in electrical communication with the electrode assembly through the header. A case plug is adhered directly to the case and to the one or more terminals so as to seal the opening in the case. The inventors have found that case plugs such as epoxy have sufficient adherence to provide a liquid tight and/or sufficiently hermetic seal to the opening in the case. As a result, the header can exclude a glass-to-metal seal and be suitable for use in or as part of active implantable medical devices. The removal of the glass-to-metal seal from the header can reduce the cost of the battery and increase the reliability of the battery.

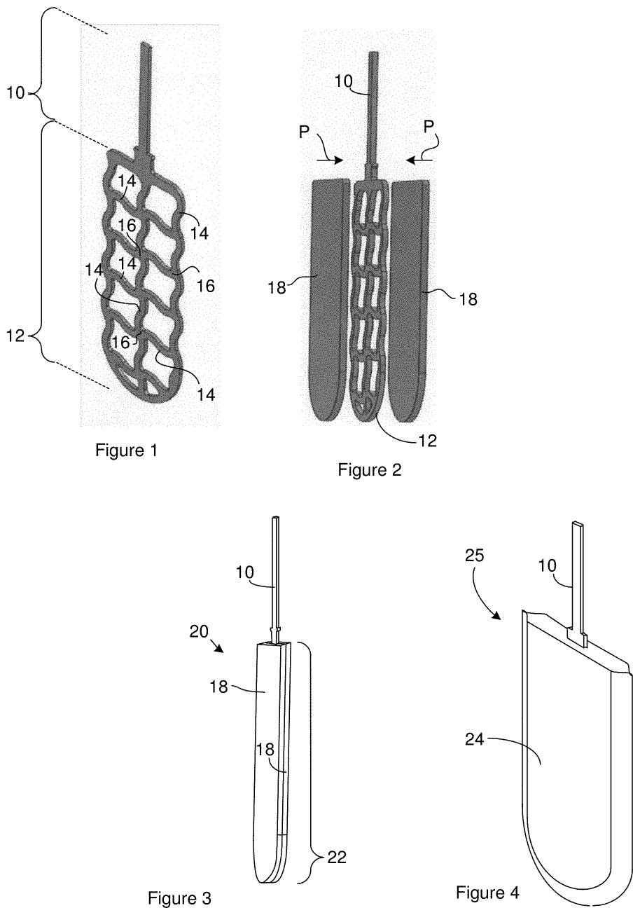

FIG. 1 through FIG. 22 illustrate a method of fabricating a battery that excludes a glass-to-metal seal. FIG. 1 is a perspective view of a cathode conductor. The cathode conductor includes a cathode tab 10 and a cathode current collector 12. The cathode tab 10 can be integrated with the cathode current collector 12 in that the cathode tab 10 and the cathode current collector 12 are constructed of a continuous material. As is evident from FIG. 1, the cathode conductor can be planar. Suitable materials for the cathode conductor include, but are not limited to, titanium, carbon coated titanium, platinum and/or iridium coated titanium, aluminum, stainless steel, nickel-based alloys, ferritic steel, highly alloyed nickel-containing ferritic stainless steel, cobalt based alloys, alloys such as Superferrit® or Elgiloy®. Suitable methods for fabricating the cathode conductor include, but are not limited to, one or more methods selecting from the group consisting of additive manufacturing, compacting and sintering a granular metal precursor, electrodeposition, processing solid sheets or foils of conductor precursor material by etching, punching, blanking, stamping, die cutting, milling, laser cutting, water jet cutting, and EDM machining.

The cathode current collector 12 includes segments 14 that connect to one another and/or to the anode tab at nodes 16. At least a portion of the segments 14 can be curved including segments 14 located at the perimeter of the current collector and/or in the interior of the current collector. All or a portion of the nodes 16 can be constructed such that all or a portion of the segments 14 connected directly to the node 16 is curved. In some instances, at least a portion of the segments 14 are constructed with a direction of curvature that changes at least once or twice along the length of the segment 14. For instance, at least a portion of the curves can be sinusoidal. In some instances, at least a portion of the segments 14 have curves that are sinusoidal and include more than half of period of the sinusoid. The curved segments 14 allow the current collector to deform within and/or out of the plane of the current collector. As a result, the current collector relieves stress that can occur during one or more events selected from the group consisting of fabricating the cathode, adding electrolyte to the cell during manufacture, charging of the cathode, and discharging of the cathode. This relief of stress can prevent breakage of strands in the current collector and reduce or eliminate permanent deformation of the current collector and/or can prevent delamination of cathode active media from the current collector.

A solid cathode active medium 18 can be positioned on both sides of the current collector as illustrated by the arrows labeled P in FIG. 2. Suitable cathode active media include one or more cathode active materials and none, one, or more than one components selected from the group consisting of binders, diluents, and conductors. Suitable cathode active materials include, but are not limited to one or more components selected from the group consisting of silver vanadium oxides, polycarbon mono-fluorides, manganese dioxide, lithium cobalt oxide, lithium nickel oxide. Suitable binders include, but are not limited to, polytetrafluoroethylene and/or polyvinylidene fluoride. Suitable diluents include, but are not limited to, one or more components selected from the group consisting of N-methyl 2-pyrrolidone, dimethylformamide, isopar, and alcohol water mixtures. Suitable conductors include, but are not limited to, one or more conductors selected from the group consisting of carbon black, graphite, graphenes, carbon nanotubes, and silver powder.

Positioning the cathode active medium 18 on the cathode current collector 12 provides the cathode assembly 20 of FIG. 3. The cathode assembly 20 includes the cathode tab 10 extending from a cathode 22. The cathode active medium 18 can be applied to the cathode current collector 12 by providing the cathode active medium as a precursor in one or more formats selected from the group consisting of pre-cut sheet, a preformed pellet (aka ‘blank’), and a charge of powder. The precursor can be introduced to the cathode current collector and compaction pressed together with the cathode current collector in a process that is maintained at ambient temperature or at an elevated temperature. An alternative possibility for applying the cathode active medium 18 to the cathode current collector 12 includes applying a slurry or paste that includes the one or more cathode active materials to the cathode current collector so as to form a coating on the cathode current collector. The result can be dried or cured and can be subsequently compaction pressed or roll pressed in a process that is maintained at ambient temperature or at an elevated temperature. Another possibility includes applying the slurry or paste to a sheet or roll of cathode conductor material so as to provide coated electrode stock that can be dried or cured and then compaction pressed or roll pressed in a process that is maintained at ambient temperature or at an elevated temperature. The result can be laser cut into individual cathode assemblies.

The cathode 22 can be positioned in a pouch 24 so as to provide a packaged cathode 25. The cathode can be positioned in the pouch 24 such that the cathode active medium 18 is located in the interior of the pouch 24 and the cathode tab 10 is accessible from outside of the pouch 24 as is evident from FIG. 4. The pouch 24 can be made of a separator material that will serve as the separator in the battery. In some instances, the separator material is folded and the edges sealed so as to form one or more seams in the pouch 24. FIG. 4 illustrates the separator material folded over the upper edge of the cathode. Suitable separator materials include, but are not limited to electrolyte permeable films that includes or consist of one or more components selected from the group consisting of polymers such as polypropylene, polyethylene, and polyvinyl chloride; blended permeable films such as polyethylene-polypropylene; composite permeable films having a multi-layer structure comprised of a combination of two or more layers of polypropylene or polyethylene or polytetrafluoroethylene; and chemically inert commercially available micro-porous separator films used for electrochemical cell or battery manufacture. Suitable methods for sealing the separator material include, but are not limited to, heat sealing, laser welding, solvent welding or solvent bonding, and adhesives. A slot can extend through the separator material and the cathode tab 10 can extend through the slot.

FIG. 5 illustrates an anode conductor. The anode conductor includes two anode current collectors 32 that are each connected to an electrically conducting bridge 34. An anode tab 36 is also connected to the bridge 34. The anode current collectors are illustrated as being constructed from a continuous material that includes segments 14 that connect to one another and to the bridge at nodes 16. At least a portion of the segments 14 can be curved including segments 14 located at the perimeter of the current collector and/or in the interior of the current collector. All or a portion of the nodes 16 can be constructed such that all or a portion of the segments 14 connected directly to the node 16 is curved. In some instances, at least a portion of the segments 14 are constructed with a direction of curvature that changes at least once or twice along the length of the segment 14. For instance, at least a portion of the curves can be sinusoidal. In some instances, at least a portion of the segments 14 have curves that are sinusoidal and include more than half of period of the sinusoid. The curved segments 14 allow the current collector to deform within and/or out of the plane of the current collector. Other constructions of the anode current collector are possible. For instance, suitable anode current collectors include, but are not limited to, meshes, screens, expanded sheets, perforated sheets, solid sheets, and foils. Suitable methods for fabricating the anode current collector include, but are not limited to, one or more methods selected from the group consisting of additive manufacturing, compacting and sintering a granular metal precursor, electrodeposition, processing solid sheets or foils of conductor precursor material by etching, punching, blanking, stamping, die cutting, milling, laser cutting, water jet cutting, and EDM machining.

The bridge 34 provides electrical communication between the anode current collectors 32 and the anode tab 36. In some instances, the anode tab 36, the bridge 34, and the anode current collector 32 are integrated in that the anode tab 36, the bridge 34, and the anode current collector 32 are constructed of a single, continuous material. Suitable materials for the components of anode conductor include, but are not limited to, metals, titanium, nickel, and stainless steel, and copper.

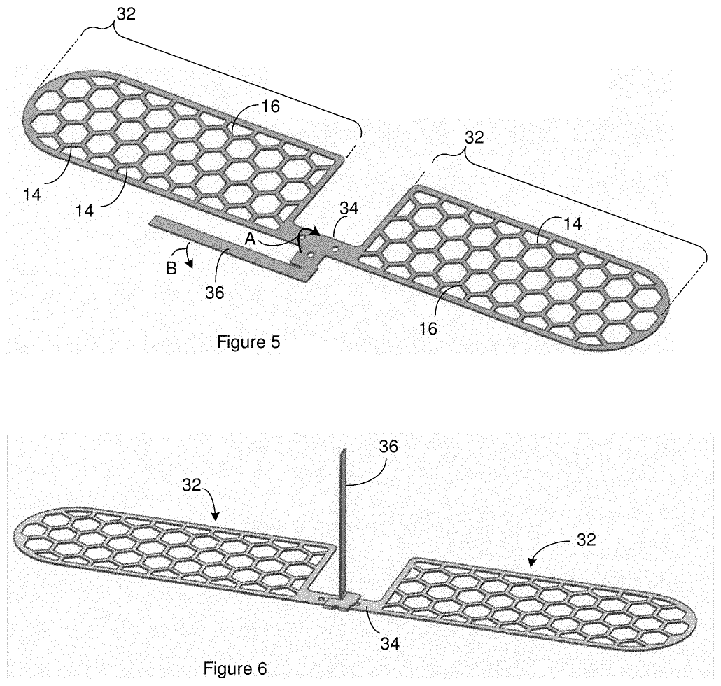

The anode conductor can be folded so as to provide the three-dimensional anode current collector 32 of FIG. 6. For instance, the bridge 34 of the anode current collector 32 can be folded back upon itself as shown by the arrow labeled A in FIG. 5 followed by folding the tab upwards as shown by the arrow labeled B in FIG. 5. Alternatively, the folds can be performed in the reverse sequence.

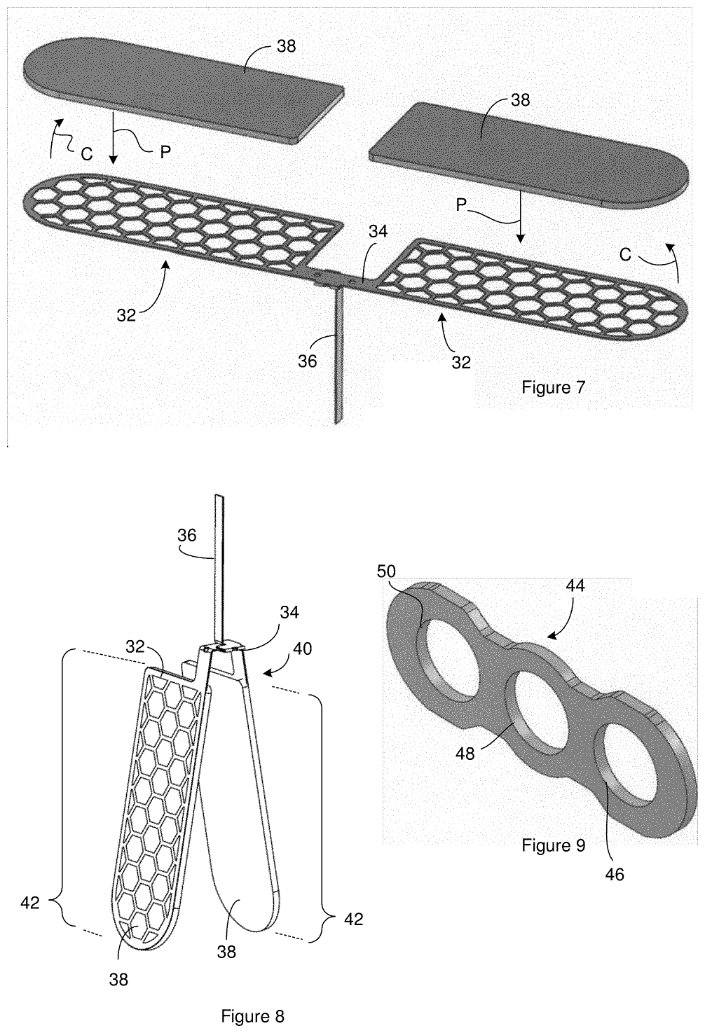

A solid anode active medium 38 can be positioned one or both sides of the anode current collectors 32. For instance, a solid anode active medium 38 can be applied to one side of each of the anode current collectors 32 as illustrated by the arrows labeled P in FIG. 7. Suitable anode active media 38 include one or more anode active materials and none, one, or more than one component selected from the group consisting of binder, diluents and conductors. Suitable anode active materials include, but are not limited to, lithium, lithium-aluminum alloys, calcium, sodium, and one or more materials selected from the group consisting of carbonatious type materials such as graphite or carbon nanotubes, silicon-based materials, and metal oxide based materials that can be admixed with a polymer binder to form a matrix that facilitates the intercalation of lithium ions. Suitable methods for applying the anode active medium 38 onto the anode current collectors 32 include, but are not limited to, compaction pressing, roll pressing, and ultrasonic bonding or ultrasonic welding. In one example, an anode active medium precursor is generated in a format selected from the group consisting of a pre-cut sheet, a preformed pellet often called a blank, and a charge of powder. The anode active medium precursor can be introduced to the anode current collector and the result compaction pressed together in a process that is maintained at ambient temperature or at an elevated temperature. An alternative possibility for applying the anode active medium to the anode current collector includes applying a slurry or paste that includes the one or more anode active materials to the anode current collector so as to form a coating on the anode current collector. The result can be dried or cured and can be subsequently compaction pressed or roll pressed in a process that is maintained at ambient temperature or at an elevated temperature. Another possibility includes applying the slurry or paste to a sheet or roll of anode conductor material so as to provide coated electrode stock that can be dried or cured and then compaction pressed or roll pressed in a process that is maintained at ambient temperature or at an elevated temperature. The result can be laser cut into individual anode assemblies. In yet another example of applying the active anode material to the anode current collector, the anode active material can be ultrasonically bonded or welded to the anode current collector.

After positioning the anode active medium 38 on the anode current collectors 32, the bridge 34 can be folded according to the arrows labeled C in FIG. 7 to provide an anode assembly 40 shown in FIG. 8. The anode assembly 40 includes anodes 42 and the anode tab 36 connected to the bridge 34.

FIG. 9 illustrates a header support 44. The header support 44 includes multiple openings extending through a planar substrate. The openings include an anode opening 46, a cathode opening 48, and an electrolyte opening 50. In some instances, the material for the substrate is the same as the material as the case of the battery and can accordingly be a metal and/or electrical conductor. Examples of suitable materials for the substrate include, but are not limited to, metals, titanium, stainless steel, and aluminum. Suitable methods for fabricating the header support 44 include, but are not limited to, one or more techniques selected from a group consisting of additive manufacturing, compacting and sintering a granular metal precursor, electrodeposition, processing sheets of header support precursor material by one or more approaches selected from the group consisting of etching, punching, blanking, stamping, die cutting, milling, laser cutting, water jet cutting, and EDM machining.

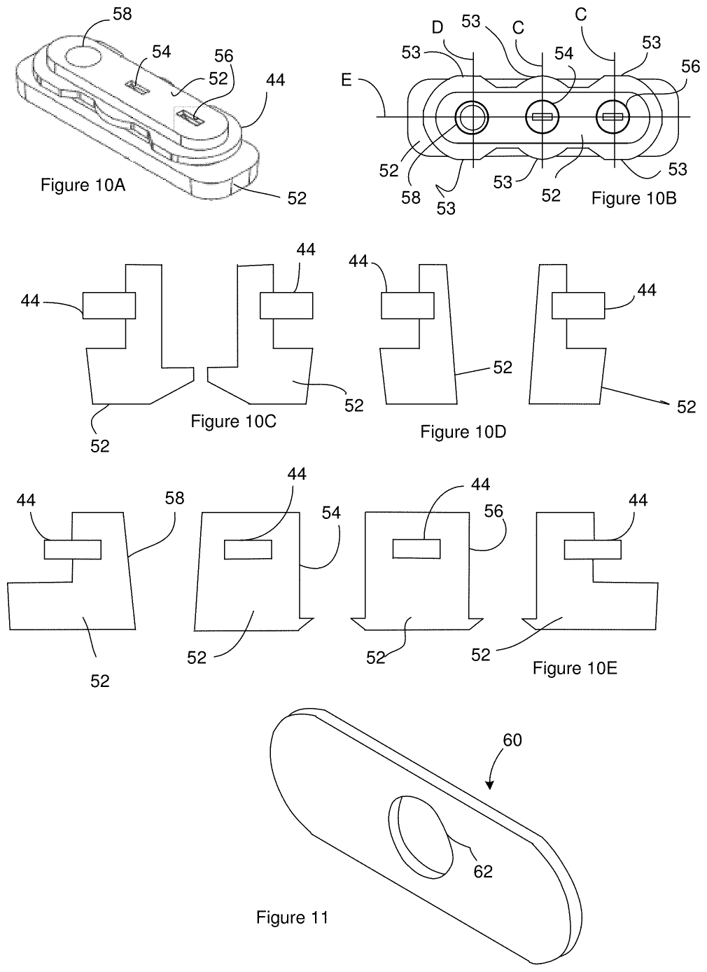

FIG. 10A through FIG. 10E illustrate a battery header that includes the header support 44 of FIG. 9. FIG. 10A is perspective view of the header. FIG. 10B is a top view of the header. FIG. 10C is a cross section of the header taken along either of the lines labeled C in FIG. 10B. FIG. 10D is a cross section of the header taken along the line labeled D in FIG. 10B. FIG. 10E is a cross section of the header taken along the line labeled E in FIG. 10B.

The header includes an insulating body 52 that can be a single continuous material that is positioned above the header support 44 and below the header support 44. In some instances, the insulating body 52 is positioned above and below the header support 44 such that a line can be drawn through the header support 44 and perpendicular to an upper and/or lower surface of the header support 44 with the line extending through the insulating body 52 on opposing sides (i.e. above and below) the header support 44. Additionally, the insulating body 52 is positioned in an interior of all or a portion of the openings in the header support 44. The insulating body 52 can be positioned in all or a portion of the openings such that the portion of the header support 44 defining the opening interior surrounds the portion of insulating body 52 in the interior of the opening. Suitable materials for the insulating body 52 include, but are not limited to, ethylene tetrafluoroethylene (ETFE), Polytetrafluoroethylene (PTFE), Fluorinated ethylene propylene (FEP), Perfluoroalkoxy alkanes (PFA), polypropylene, polyethylene, polyamide, and polymers that are chemically inert and electrically insulative to the battery electrochemistry. Suitable methods of fabricating the insulating body 52 include, but are not limited to, additive manufacturing, injection molding, insert injection molding, and thermoforming.

The header support 44 can be partially embedded in the insulating material as is most evident in FIG. 10C through FIG. 10E. As a result, a portion of the header support 44 can be accessible from outside of the header. The accessible portion of the header support 44 can be welded to different parts of the battery such as the battery case. For instance, the header of FIG. 10A through FIG. 10E includes six exposed weld locations 53 that can be welded to the case of the battery. In some instances, all or a portion of each weld location contacts the case.

The insulating body 52 can define one or more passageways that extend through the insulating body 52 from one surface of the insulating body 52 to another opposing surface of the insulating body such as an opposing surface of the insulating body. The insulating body 52 can be positioned in all or a portion of the openings in the header support 44. FIG. 10A through FIG. 10E illustrate the insulating body 52 positioned in each of the openings in the header support. The passageways defined by the insulating body 52 each extends through one of the openings in the header support 44. Additionally, the header support 44 can surround the portion of the insulating body 52 positioned in an opening of the header support 44. In some instances, the insulating body 52 is positioned in an opening such that none of the passageway is defined by the header support 44. As will become evident below, the passageways are configured for passage of an electrode tab, plug, and/or electrolyte through the header. The header of FIG. 10A through FIG. 10E includes a cathode passageway 54, and anode passageway 56 and an electrolyte passageway 58.

The battery can optionally include a retainer 60 that maintains a separation between the cathode tab 10 and the anode tab 36 in the final electrode assembly 64 sometimes called a “cell stack.” FIG. 11 is a perspective view of an example of a retainer 60. The retainer 60 includes a cathode hole 62 extending through a retainer substrate and can include an optional electrolyte hole (not shown) extending through a retainer substrate. When the battery includes a retainer 60, the retainer 60 can be positioned between the header and an electrode assembly 64 that includes the packaged cathode 25 and the anode assembly 40. The cathode tab 10 from the packaged cathode 25 can pass through the cathode hole 62. In some instances, the cathode hole 62 is sized such that the edges of the cathode tab 10 contact the resistance substrate to retain the position of the tab relative to the retainer 60. The retainer substrate can be electrically insulating. Suitable materials for the retainer substrate include, but are not limited to, ETFE, PTFE, FEP, PFA, polypropylene, polyethylene, polyamide, and polymers that are chemically inert and electrically insulative to the battery electrochemistry. Suitable methods of fabricating the retainer 60 include, but are not limited to, additive manufacturing, punching and/or die cutting from a precursor of retainer material sheet stock, thermoforming with subsequent die cutting, and injection molding.

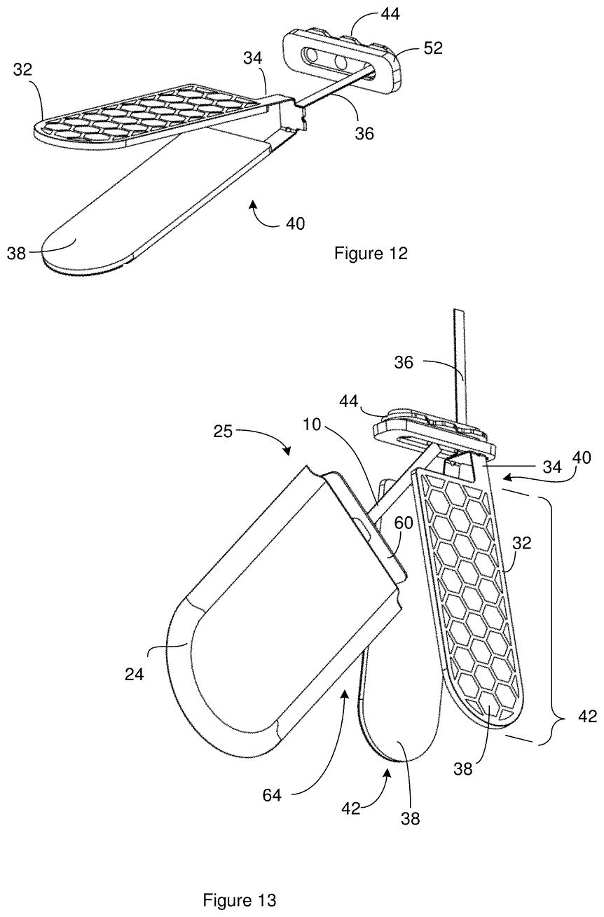

The anode tab 36 from the anode assembly 40 can be inserted through the anode passageway as shown in FIG. 12. The anode passageway is configured to provide a liquid seal between the tab and the insulating body 52. In one example, the liquid seal is a result of an interference fit between the tab and the insulating body 52. For instance, a region of the insulating body 52 that contacts the anode tab 36 can surround the anode tab 36.

The cathode tab 10 from the packaged cathode 25 can be inserted through the cathode passageway 54 as shown in FIG. 13. The cathode passageway 54 is configured to provide a liquid seal between the tab and the insulating body 52. In one example, the liquid seal is a result of an interference fit between the tab and the insulating body 52. For instance, the insulating body 52 can contact the cathode tab 10 at a location that surrounds the cathode tab 10.

As is evident from FIG. 13, the cathode is positioned between the anodes so as to provide an electrode assembly 64 having anodes alternating with cathodes and a separator between adjacent anodes and cathodes.

When the battery is to include a retainer 60, the cathode tab 10 from the packaged cathode is passed through the cathode hole 62 in the retainer 60 before being passed through the cathode passageway 54 as shown in FIG. 13. When the electrode assembly 64 is assembled, the retainer 60 is positioned between different regions of the bridge 34 included in the anode assembly 40. As a result, the bridge 34 of the anode assembly 40 is positioned on opposing sides of the retainer substrate allowing the anode assembly 40 to straddle the retainer 60.

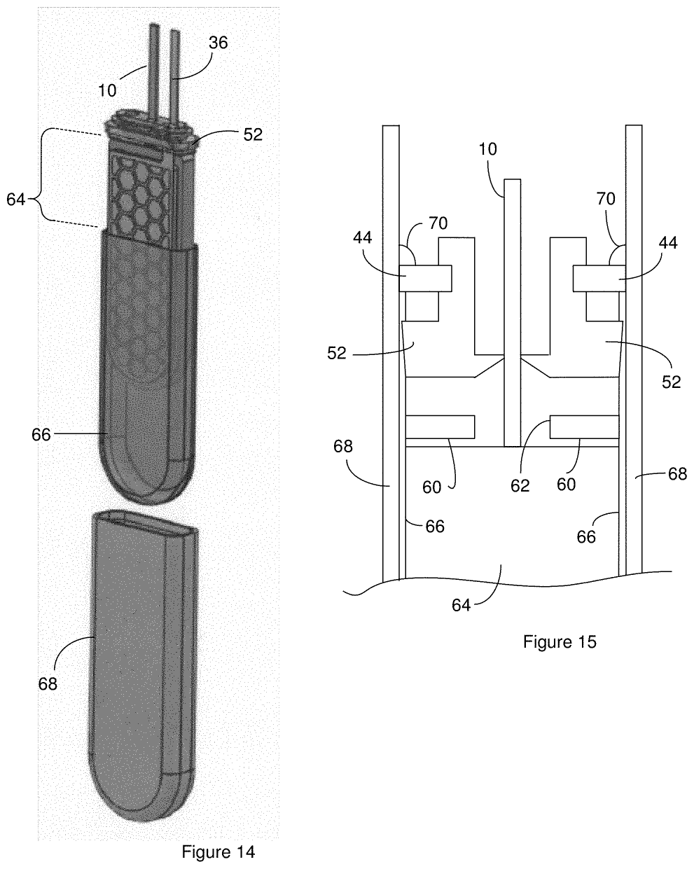

The electrode assembly 64 is positioned in an insulating boot 66 as shown in shown in FIG. 14. The boot 66 can have an opening at one end and be closed at the other end. In some instances, the boot 66 has only one opening. The electrode assembly 64 can be inserted into the interior of the boot 66 through the opening. The combination of the boot 66 and electrode assembly 64 can be positioned in a case 68 as is also shown in shown in FIG. 14. The case 68 can have an opening at one end and be closed at the other end. In some instances, the boot 66 has only one opening. The boot 66 and electrode assembly 64 can be inserted into the interior of the case 68 through the opening. The boot 66 can be electrically insulating. Suitable materials for the insulating boot 66 include, but are not limited to, ETFE, PTFE, FEP, PFA, polypropylene, polyethylene, polyamide, and polymers that are chemically inert and electrically insulative to the battery electrochemistry. Suitable materials for the battery case 68 include, but are not limited to, metals, titanium, stainless steel, and aluminum.

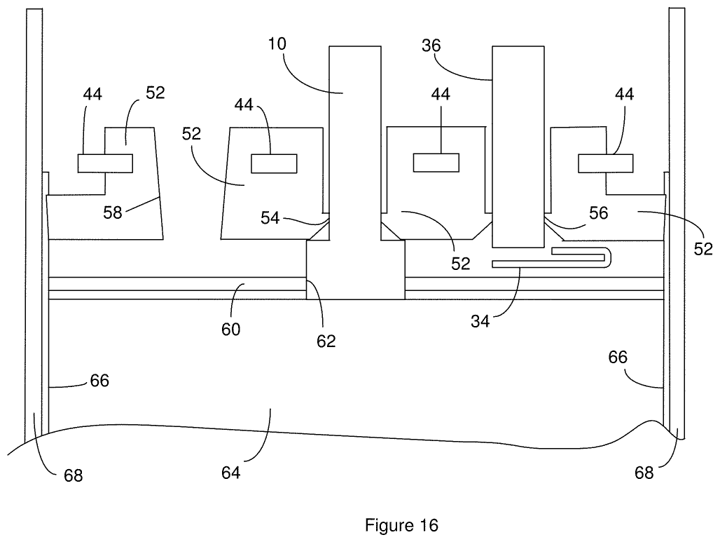

FIG. 15 and FIG. 16 are cross sections of the battery precursor that results from the assembly process shown in FIG. 14. FIG. 15 is a cross section of the battery precursor taken through the cathode tab 10. FIG. 16 is a cross section of the battery precursor taken through the cathode tab 10 and also through a portion of the anode tab 36. The cross section of FIG. 16 can be perpendicular to the cross section of FIG. 15. The details of the electrode assembly 64 are not shown in FIG. 15 and FIG. 16.

The case 68 extends above the header. All or a portion of the insulating body 52 can be positioned in an interior of the boot 66. In the embodiment shown in FIG. 15 and FIG. 16, the header support 44 is not positioned in an interior of the boot 66 although other configurations are possible. The boot 66 physically contacts the insulating body 52. The boot 66 can be between the insulating body 52 and the case 68 and can contact both the insulating body 52 and the case 68 as shown in FIG. 15. A region of contact between the boot 66 and the insulating body 52 can surround the insulating body 52. There can be a liquid seal between the boot 66 and the insulating body 52. In one example, the liquid seal is a result of an interference fit between the boot 66 and the insulating body 52. FIG. 15 illustrates an interference fit between the boot 66 and the insulating body 52 where the insulating body 52 compresses a portion of the boot 66 against the case 68. The combination of the boot 66 and the insulating body 52 electrically insulate the case 68 and the header support 44 from the electrode assembly 64 and an electrolyte that can be a liquid (not shown).

Any exposed weld locations on the header support 44 can optionally be welded to the case 68 as shown in FIG. 15. When the header support 44 is constructed of a rigid or substantially rigid material, the welds 70 can reduce or prevent movement of the header in relation to case 68 and/or reduce or prevent outward expansion of the case 68 during charge and/or discharge of the battery and are optional. In some instances, all or a portion of each weld region contacts the case 68 as shown in FIG. 15.

FIG. 15 and FIG. 16 show the retainer 60 spaced apart from the electrode assembly 64; however, the retainer 60 can contact the header and/or the electrode assembly 64. Optional contact between the edges of the cathode tab 10 and the edges that define the cathode hole 62 can help maintain the location of the retainer 60 relative to the electrode assembly 64 and/or reduce movement of the cathode tab 10 within the battery.

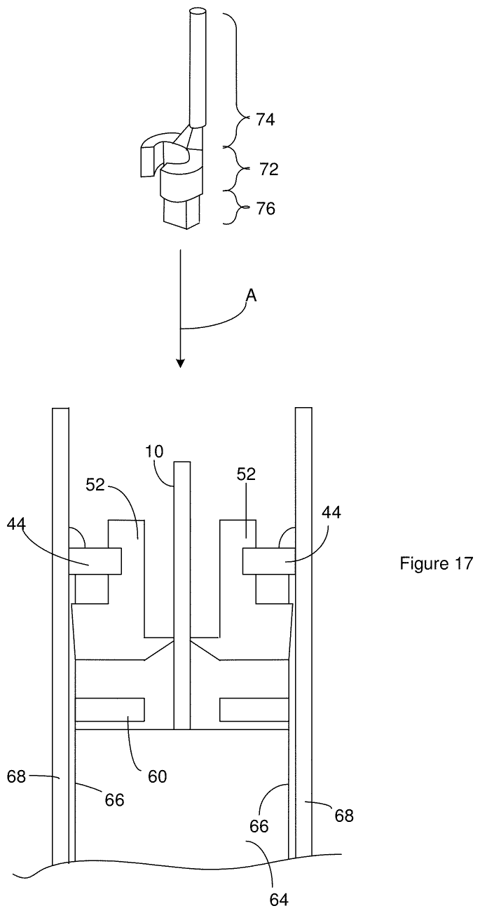

In some instances, the anode tab 36 and/or the cathode tab 10 from the electrode assembly 64 can operate as the battery terminals. In other instances, a terminal can be attached to the anode tab 36 and/or the cathode tab 10. For instance, FIG. 17 illustrates a terminal assembly that includes an attachment region 72 between a terminal 74 and a projection 76 such as a tang. The attachment region 72 includes an attachment mechanism configured to connect the terminal 74 to a tab from an electrode. Suitable attachment mechanisms include, but are not limited to, clasps, welds, ultrasonic bonds, conductive epoxies, conductive adhesives, solders, wire bonds, and crimpings. The attachment region 72 in the terminal assembly of FIG. 17 includes a clasp that serves as the attachment mechanism.

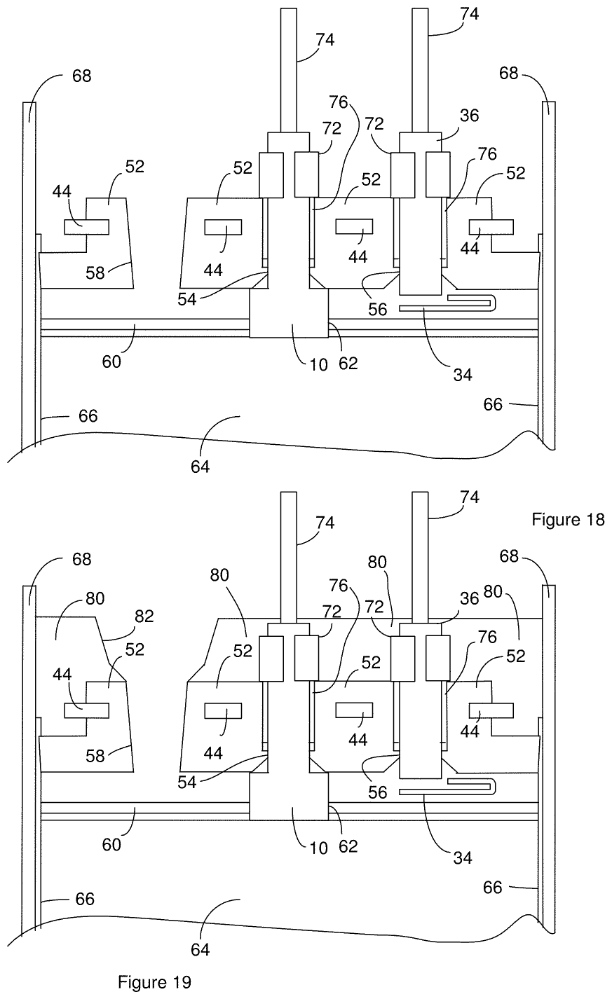

During assembly of the battery, the projection 76 of a terminal assembly can be positioned in the cathode passageway 54 or the anode passageway 56 of the header and the tab positioned in the interior of the tab as shown by the arrow labeled A in FIG. 17. The clasp can be crimped to the received tab in order to immobilize the clasp relative to the tab. FIG. 18 is a cross section of the battery precursor after connection of terminal assemblies to the cathode tab 10 and the anode tab 36 from the battery precursor of FIG. 15 through FIG. 17. The cathode tab 10 and the anode tab 36 each provides an electrical pathway for electrical communication between at least one of the respective electrodes in the electrode assembly 64 and one of the terminals 74. The electrical pathways each extends through the header through one of the passageways through the header. In some instances, the terminal assembly is constructed of a single and continuous material. Suitable materials for the terminal assembly include, but are not limited to, titanium, aluminum, stainless steel, nickel, copper, silver, gold, beryllium copper, metals, and electrically conductive composite materials.

A first case plug 80 can be positioned over the header so as to plug the end of the case 68 above header as shown in FIG. 19. The first case plug 80 can contact the case and one or more of the terminal assemblies. In some instances, the first case plug 80 contacts the case 68 and at least one of the terminals 74 and/or terminal assemblies. The first case plug 80 can be formed such that an electrolyte conduit 82 extends through the first case plug 80. In some instances, the first case plug 80 is formed such that the end of the case 68 is sealed with the exception of the electrolyte conduit 82. The electrolyte conduit 82 is aligned with the electrolyte passageway 58 such that the combination of the electrolyte conduit 82 and the electrolyte passageway 58 provide an electrolyte pathway from outside of the battery precursor, through the header, and into the interior of the boot 66.

The case 68 can be filled with a liquid electrolyte (not shown) through the electrolyte pathway. Suitable electrolytes include, but are not limited to, one or more salts in one or more solvents. Examples of suitable salts include, but are not limited to, lithium hexafluorophosphate, tetrafluoroborate, hexafluoroarsenate, TFSI, TFI, FSI, and perchlorate. Examples of suitable solvents include, but are not limited to, propylene carbonate, carbonate, ethylene carbonate, gamma-butyrolactone, organic carbonates, and organic ethers.

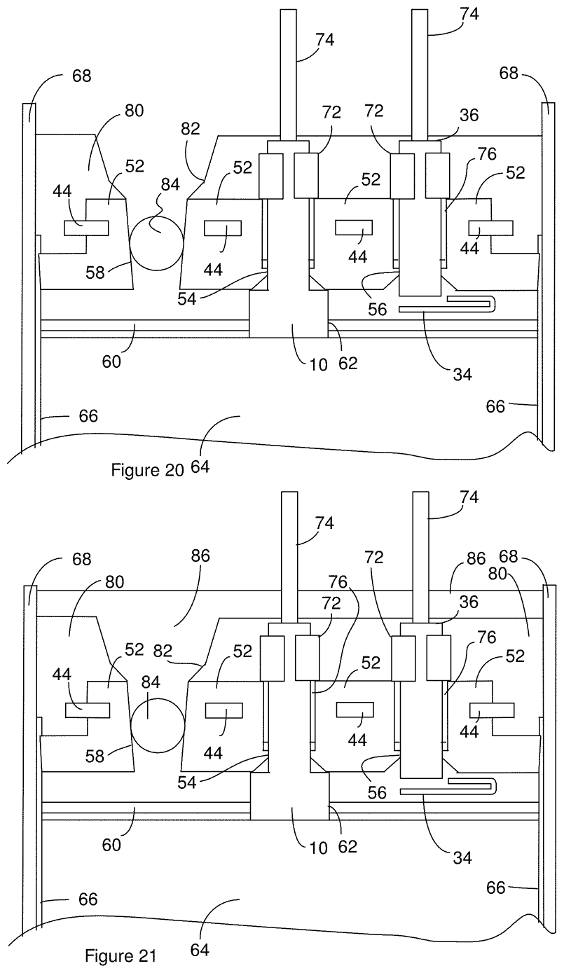

After placement of the electrolyte in the interior of the boot 66, a plug 84 can be positioned in the electrolyte pathway as shown in FIG. 20. The plug 84 can be configured such that there is an interference fit between the plug 84 and the insulating body 52 and/or the first case plug 80. As a result, the plug 84 can contact at least a portion of the insulating body 52 that defines the electrolyte pathway and/or the first case plug 80 that defines the electrolyte pathway. The interference fit and/or contact can be such that the plug 84 seals one or more paths selected from the group consisting of the electrolyte pathway, electrolyte conduit 82 and the electrolyte passageway 58. A suitable shape for electrolyte plug 84 includes, but is not limited to, a sphere, a cylinder, a frustoconical pin shape, and headed pin shape. A suitable material for the plug includes, but is not limited to, glass, ETFE, PTFE, FEP, PFA, polypropylene, polyethylene, titanium, stainless steel, aluminum, and metals and polymers that are inert when exposed to the battery electrochemistry.

A second case plug 86 can be positioned in the case 68 and over the first case plug 80 such that the first case plug 80 is between the header and the second case plug 86 as shown in the battery of FIG. 21. The second case plug 86 can seal the electrolyte pathway. In some instances, the second case plug 86 is formed such that the second case plug 86 seals the opening in the case 68. For instance, the second case plug 86 can contact all or a portion of the components selected from the group consisting of the plug, the case 68, one or more of the terminal assemblies, one or more of the terminals 74, the first case plug 80, and at least a portion of the insulating body 52 that defines the electrolyte pathway and/or the first case plug 80 that defines the electrolyte pathway. The second case plug 86 can contact the case and one or more of the terminals 74 and/or terminal assemblies. In some instances, the first case plug 80 contacts at least the case, the plug, and at least one of the terminals. The terminals 74 of the terminal assemblies extend above the second case plug 86 and can be accessed from the atmosphere in which the battery is positioned. As a result, the terminals 74 of the terminal assemblies can act as the terminals for the battery.

Suitable methods of forming the first case plug 80 and/or the second case plug 86 include, but are not limited to, placing a liquid plug precursor into the interior of the battery case 68 above the header and converting the liquid plug precursor into a solid that acts as the first case plug 80 or the second case plug 86. The conversion can include or consist of one or more actions selected from the group consisting of allowing the passage of time, application of heat to the liquid plug precursor, causing a chemical reaction in the liquid plug precursor, UV curing, and catalytic curing. Suitable liquid plug precursors include, but are not limited to, one or more compound selected from the group consisting of: epoxy resins, silicones, urethanes, thermosetting polymers, adhesives, glues, and, acrylics.

Suitable solids that can act as the first case plug 80 and/or the second case plug 86 include, but are not limited to, polymers including polymers with a melting temperature below 180° C., thermoplastic polyolefins such as polypropylene, polyethylene, and blends of polyethylene and polypropylene. In some instances, the first case plug 80 and/or the second case plug 86 includes, consists of, or consists essentially of a polymer or a cross-linked polymer. In one example, the polymer or cross-linked polymer includes, consists of, or consists essentially of a cured epoxy. When the polymer is a cured epoxy resin, the epoxy resin can be cured by homopolymerisation or forming a copolymer with polyfunctional curatives or hardener. Suitable epoxy resins are monomers that each include one or more epoxide functional groups. The cured epoxy resin can include or exclude one or more epoxide functional groups.

Examples of the first case plug 80 and/or the second case plug 86 are plugs that include, consists of, or consists essentially of 3748 Hot Melt Adhesive (McMaster p/n 7333A16) from 3M Corporation, EPDM (ethylene propylene diene monomer) Rubber (McMaster p/n 9557K471) from Parker Corporation, Aflas® Fluoroelastomer Rubber (McMaster p/n 5240T48) from Aflas®, Viton® Fluoroelastomer Rubber (McMaster p/n 9464K23), Specialty Silicone Coating 412A&B (McMaster p/n 74965A22) from Chem-Set™, Epoxy Adhesive 305-1/2 (McMaster p/n 66195A31) from Lord Corporation, and Thermoset ME-455 Encapsulant from Lord Corporation.

The first case plug 80 and the second case plug 86 can act together to form a case plug that seals the opening in the case 68. For instance, the case plug can contact all or a portion of the components selected from the group consisting of the plug, the case 68, one or more of the terminal assemblies, one or more of the terminals 74, the first case plug 80, and at least a portion of the insulating body 52 that defines the electrolyte pathway and/or the first case plug 80 that defines the electrolyte pathway. The use of epoxies as the first case plug 80 and/or the second case plug 86 provides a sufficiently hermetic seal and can accordingly make the battery suitable for use in implantable medical devices. Further, the use of epoxies as the first case plug 80 and/or the second case plug 86 provides the structural integrity needed for the battery to withstand the charging and discharging process. As a result, the welds 70 disclosed above are not required and are optional.

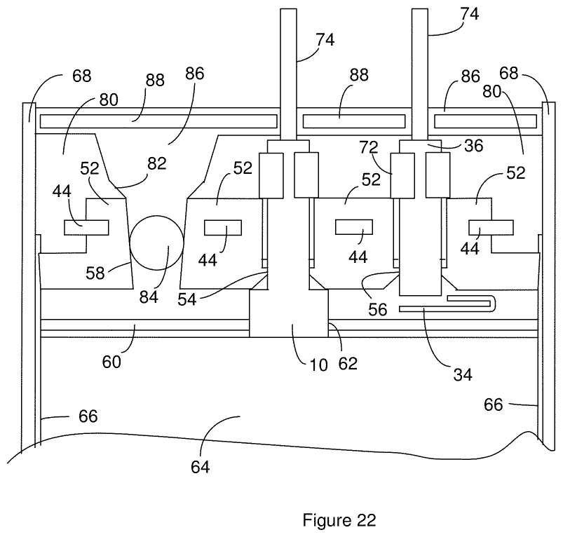

In some instances, it may be desirable for the first case plug 80 and/or the second case plug 86 to include a vapor barrier 88. For instance, FIG. 22 is a cross section of the battery in FIG. 21 modified such that the second case plug 86 includes a vapor barrier 88. Although the vapor barrier 88 is shown as spaced apart from the case and the terminals 74 or terminal assemblies, the vapor barrier 88 can contact the case 68 and the terminal assemblies. Each of the terminals 74 or terminal assemblies can be surrounded by the vapor barrier 88. When the first case plug 80 and/or the second case plug 86 are fabricated by placing a liquid plug precursor into the interior of the battery case 68 above the header, the vapor barrier 88 can be placed in the liquid before or during the conversion to the solid that acts as the first case plug 80 or the second case plug 86. Suitable vapor barriers 88 include, but are not limited to, thin format chemically strengthened glass sheet products made by companies such as Corning Inc., AGC, Inc., or Schott AG; for example, a suitable vapor barrier precursor is Corning's Willow® glass sheet product.

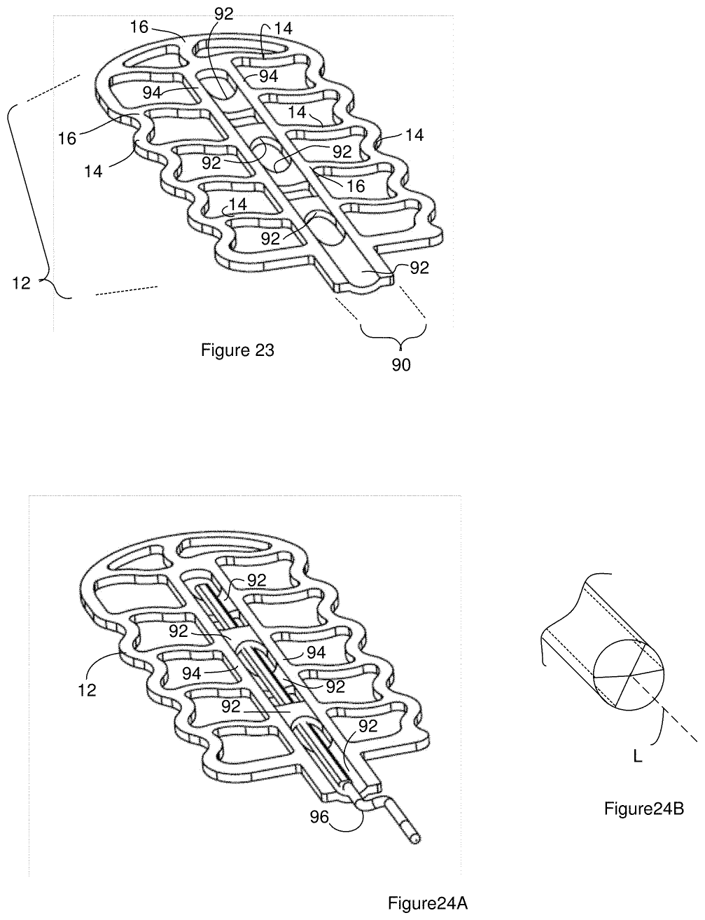

The battery can be modified to use alternative electrode constructions. For instance, FIG. 23 is perspective view of a cathode conductor. The cathode conductor includes a pin seat 90 and a cathode current collector 12 extending outward from the perimeter of the pin seat 90. The pin seat 90 can be integrated with the cathode current collector 12 in that the pin seat 90 and the cathode current collector 12 are constructed of a continuous material.

The pin seat 90 includes retainers 92 extending from supports 94 with the retainers 92 arranged so as to constrain a position of a pin on the pin seat 90. For instance, the pin seat 90 can hold a pin 96 as illustrated in FIG. 24A. The retainers 92 can include an engagement surface configured to contact the pin 96. The engagement surface can have a shape that is complementary or substantially complementary to the surface of the pin 96 so a portion of the pin 96 is effectively held by the engagement surface. For instance, a region of the pin 96 can have a curved surface and the engagement surface can be curved with a radius of curvature that, matches, substantially matches, or is larger than the radius of curvature of the region of the pin 96. As a result, the engagement surface and the pin 96 can be mated parts. The retainers 92 are positioned so they are located at several different locations along the length of the pin 96. In some instances, there are at least three retainers 92 positioned along the length of the pin 96.

As is evident in FIG. 24B, the pin 96 is configured such that multiple three-dimensional wedges can be drawn on the pin 96 with the wedges arranged around the lateral axis of the pin 96. The wedges each include at least two straight sides that intersect at the lateral axis and another side that is defined by the surface of the pin 96. An additional dimension of the wedge results from the wedge extending along the length of the pin 96. The retainers 92 are arranged such that when the pin 96 is received in the pin seat 90, different retainers 92 are over different wedges in that a ray can be drawn originating from the lateral axis and then through a retainer 92 positioned over the wedge. As a result, in FIG. 24A, a first portion of the retainers 92 that are each positioned over a first wedge without being positioned over a second wedge and a second portion of the retainers 92 that are each positioned over a second wedge without being positioned over the first wedge. In some instances, the first wedge does not overlap with the second wedge and/or the first wedge and a line through the lateral axis can also pass through the first wedge and the second wedge.

The retainers 92 can be positioned so as to restrict movement in opposite directions relative to the supports 94. For instance, the retainers 92 can be positioned so as to restrict movement of the pin 96 in a direction above the current collector and to restrict movement in a direction below the current collector. As an example, FIG. 23 and FIG. 24A show a portion of the retainers 92 extending from the supports 94 in a direction above the supports 94 and a portion of the retainers 92 that extend from the supports 94 in a direction below the supports 94. The retainers 92 extending in a first direction from the supports 94 can alternate with the retainers 92 extending in the opposite direction from the support 94 to form a channel in which the pin 96 can be positioned. As a result, the pin 96 can be received such that a first portion of the retainers 92 are located above the pin 96 without being located below the pin 96 and a second portion of the retainers 92 are located below the pin 96 without being located above the pin 96.

As is evident from FIG. 23 and FIG. 24A, the cathode current collector 12 can be planar or substantially planar. A first portion of the retainers 92 extend outward from the plane defined by the current collector in a first direction and in a second portion of the retainers 92 extend outward from the plane defined by the current collector in a second direction. For instance, the first portion of the retainers 92 extend above the plane defined by the current collector and the second portion of the retainers 92 extend below the plane defined by the current collector. As a result, the movement of the pin 96 outside of the plane is limited by the retainers 92.

The pin 96 can be attached to the pin seat 90 so as to immobilize the pin 96 relative to the cathode current collector 12. Suitable attachment mechanisms include, but are not limited, to welds, brazes, solders, ultrasonic bonds, and encapsulation with an electrically conductive coating. In some instances, one or more welds (not shown) between the pin 96 and retainers 92 attach the pin 96 to the pin seat 90. Suitable attachment techniques include, but are not limited to, ultrasonic welding, laser welding, resistance welding, brazing, soldering, and laser welding. Another suitable attachment technique includes interleaving the pin 96 between alternating retainers 92 and pressing the alternating retainers 92 against the pin 96 so each of the retainers 92 concurrently contacts the pin 96 and traps the pin 96 along directions that are essentially perpendicular to the outermost principal planar surfaces of current collectors 12. The result can optionally be coated on what is essentially the entire cathode conductor along with the portion of the pin 96 adjacent to pin seat 90 along with essentially most or all of pin seat 90. Another attachment technique includes interleaving cathode terminal pin 96 between alternating retainers 92 and pressing the alternating retainers 92 against the pin 96 so each of the retainers 92 concurrently contacts the pin 96 and traps the pin 96. The exposed portions of the pin seat 90 and the exposed portions of cathode terminal pin 96 can be coated so as to encapsulate the interface between cathode terminal pin 96 and pin seat 90. Suitable coatings include, but are not limited to, conductive coatings that include or consist of carbon. An example of a conductive coating that includes carbon is a slurry that includes a graphite pigment admixed within an epoxy resin that is subsequently cured or dried to form the applied coating.

The cathode current collector 12 includes segments 14. The segments 14 connect to each other and/or to one of the supports 94 at nodes 16. At least a portion of the segments 14 can be curved including segments 14 located at the perimeter of the current collector and/or in the interior of the current collector. All or a portion of the nodes 16 can be constructed such that all or a portion of the segments 14 connected directly to the node 16 is curved. In some instances, at least a portion of the segments 14 are constructed with a direction of curvature that changes at least once or twice along the length of the segment 14. For instance, at least a portion of the curves can be sinusoidal. In some instances, at least a portion of the segments 14 have curves that are sinusoidal and include more than half a period of the sinusoid.

Suitable materials for the pin 96 include, but are not limited to, titanium, Platinum/Iridium coated titanium, aluminum, stainless steel, nickel-based alloys, ferritic steel, highly alloyed nickel-containing ferritic stainless steel, cobalt based alloys, alloys such as Superferrit® or Elgiloy®. Suitable materials for the cathode conductor include, but are not limited to, titanium, Platinum/Iridium coated titanium, aluminum, stainless steel, nickel-based alloys, ferritic steel, highly alloyed nickel-containing ferritic stainless steel, cobalt based alloys, and alloys such as Superferrit® or Elgiloy®. Suitable methods for fabricating the cathode conductor include, but are not limited to, additive manufacturing, compacting and sintering a granular metal precursor, electrodeposition, processing sheets of cathode conductor precursor material by etching, punching, blanking, stamping, die cutting, milling, laser cutting, water jet cutting, and EDM machining. In some instances, all or a portion of the cathode terminal pin 96 is metal plated. For instance, all or a portion of the cathode terminal pin 96 can be gold plated.

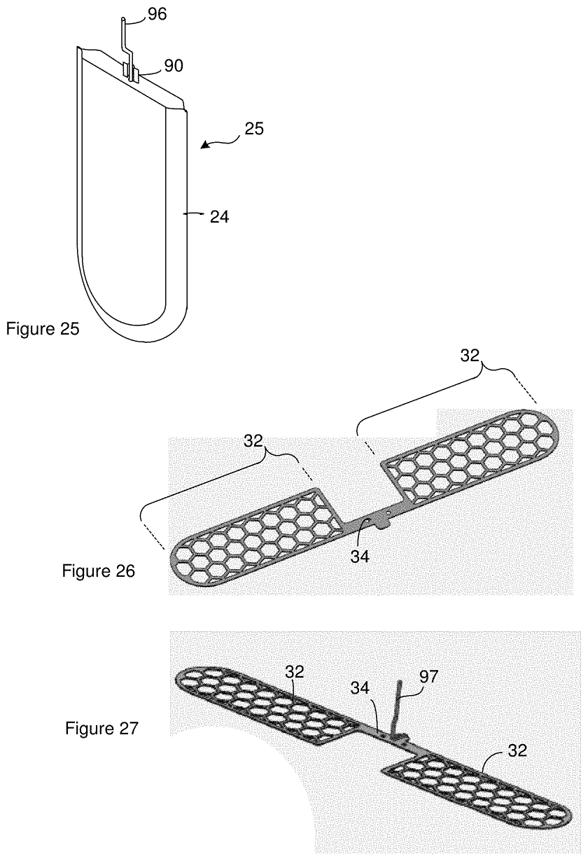

As described above in at least the context of FIG. 2, cathode active media can be pressed on the cathode current collector 12 and the pin seat 90 to provide a cathode assembly that includes the pin 96 extending from a cathode. A portion of the cathode assembly can be positioned in a pouch 24 so as to provide the packaged cathode 25 of FIG. 25. As noted above, the pouch 24 can be made of a separator material that will serve as the separator in the battery. The pin 96 from the cathode assembly extends from the pouch.

FIG. 26 is a perspective view of an anode conductor that is suitable for use with the packaged cathode 25 of FIG. 25. The anode conductor is constructed according to FIG. 5 but excludes the tab. A pin 97 can be connected to the bridge 34 as shown in FIG. 27. Suitable attachment mechanisms include, but are not limited, to welds, brazes, solders, ultrasonic bonds, and crimps. In some instances, the pin 97 is welded to the bridge 34. Suitable attachment techniques include, but are not limited to, ultrasonic welding, laser welding, resistance welding, brazing, soldering, wire bonding, and ultrasonic bonding.

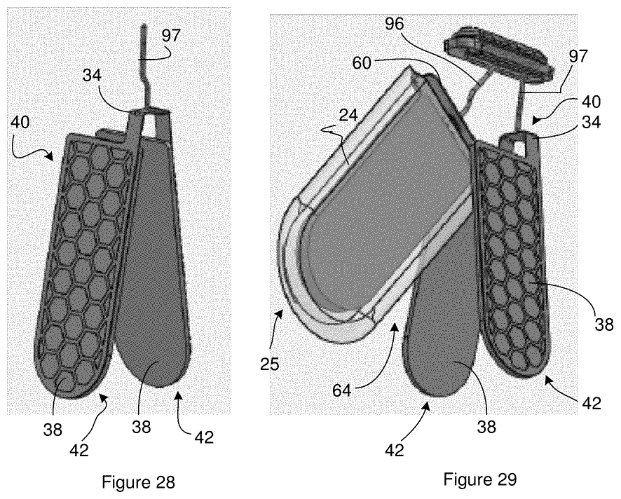

The anode active medium 38 can be pressed on the anode current collectors 32 and the anode conductor folded so as to provide the anode assembly 40 of FIG. 28. The header can be constructed as disclosed in the context of FIG. 9 through FIG. 10E with the geometry of respective passageways adapted to accommodate cathode pin 96 and anode pin 97. The pin 97 of the anode assembly 40 of FIG. 28 can be inserted through the anode passageway in the header as shown in FIG. 29 and FIG. 31. The portion of the insulating body 52 that defines the anode passageway 56 is configured to provide a liquid seal between the pin 97 and the insulating body 52. In one example, the liquid seal is a result of an interference fit between the pin 97 and the insulating body 52. For instance, a region of the insulating body 52 that contacts the pin 97 can surround the pin 97 of the anode assembly 40.

The pin 96 of the packaged cathode can be inserted through the cathode passageway 54 as shown in FIG. 29 and FIG. 31. The cathode passageway 54 is configured to provide a liquid seal between the pin 96 and the insulating body 52. In one example, the liquid seal is a result of an interference fit between the pin 96 and the insulating body 52. For instance, a region of the insulating body 52 that contact the pin 96 can surround the pin 96 from the packaged cathode.

As is evident from FIG. 29, the packaged cathode 25 is positioned between the anodes 42 so as to provide an electrode assembly 64 having one or more anodes alternating with one or more cathodes and a separator between adjacent anodes and cathodes.

When the battery is to include a retainer 60, the pin 96 of the packaged cathode is passed through the cathode hole 62 in the retainer 60 before being passed through the cathode passageway 54 as shown in FIG. 29 through FIG. 31. When the electrode assembly 64 is assembled, the retainer 60 is positioned between different regions of the bridge 34 included in the anode assembly 40. As a result, the bridge 34 of the anode assembly 40 is positioned on opposing sides of the retainer substrate allowing the anode assembly 40 to straddle the retainer 60.

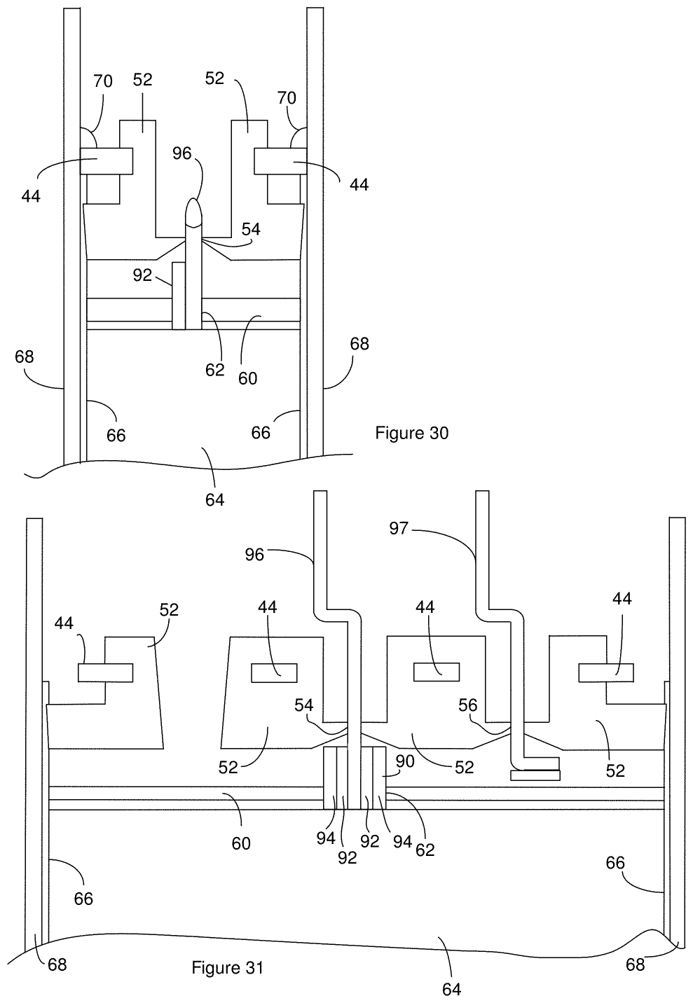

The electrode assembly 64 is positioned the insulating boot 66 and the result can be positioned in the case 68 to provide a battery precursor as disclosed above. FIG. 30 and FIG. 31 are cross sections of the battery precursor that results from the assembly process disclosed in the context of FIG. 23 through FIG. 29. FIG. 30 is a cross section of the battery precursor taken through the pin 96 from the cathode assembly. FIG. 31 is a cross section of the battery precursor taken through the pin 96 from the cathode assembly and the pin 97 from the anode assembly. The cross section of FIG. 30 can be perpendicular to the cross section of FIG. 31. The details of the electrode assembly 64 are not shown in FIG. 30 and FIG. 31.

FIG. 30 shows exposed weld locations 53 on the header support 44 welded to the case 68, however, these welds 70 are optional and are not needed to maintain a hermetic seal. There can be a liquid seal between the boot 66 and the insulating body 52. In one example, the liquid seal is a result of an interference fit between the boot 66 and the insulating body 52. FIG. 30 and FIG. 31 each illustrates an interference fit between the boot 66 and the insulating body 52 where the insulating body 52 compresses a portion of the boot 66 against the case 68. FIG. 30 and FIG. 31 show the optional retainer 60 spaced apart from the electrode assembly 64, however, the retainer 60 can contact the header and/or the electrode assembly 64. The cathode hole 62 in the retainer 60 can be configured to contact the pin 96/or pin seat 90 so as to help maintain the location of the retainer 60 relative to the electrode assembly 64 and/or reduce movement of the pin 96 within the battery. In some instances, the cathode hole 62 in the retainer 60 contacts the pin 96 and/or pin seat 90 at a location that surrounds the pin 96.

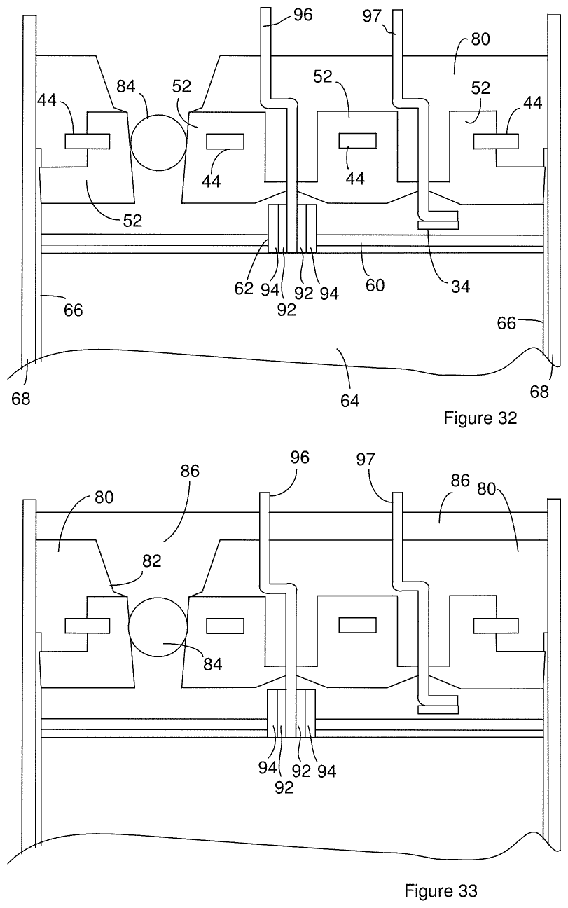

The first case plug 80 can be positioned over the header in the battery precursor of FIG. 31 so as to provide the battery precursor of FIG. 32. The case 68 can be filled with the liquid electrolyte through the electrolyte pathway and the plug 84 can be positioned in the electrolyte pathway. The second case plug 86 can be positioned over the header in the battery precursor of FIG. 32 so as to provide the battery precursor of FIG. 33. The pin 96 and pin 97 each extends above the second case plug 86 so they can be accessed from the atmosphere in which the battery is positioned. As a result, the pin 96 and pin 97 can serve as the terminals for the battery. Accordingly, at least one pin selected from the group consisting of the pin 96 and the pin 97 is both embedded in an active medium and also serves as a battery terminal. Additionally, though not shown in FIG. 33, optional vapor barrier 88 can be employed in the battery of FIG. 33.

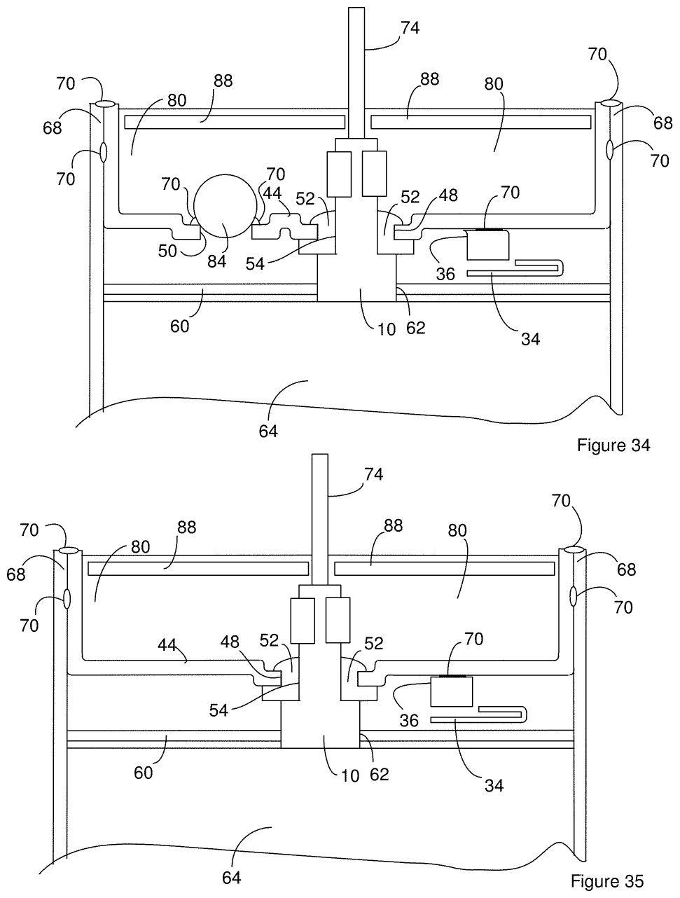

The battery components disclosed above can be re-arranged to provide different features. For instance, the battery can have one or more features selected from a group consisting of a case that serves as a terminal such as a case-positive battery or a case-negative battery, a single terminal in electrical communication with one or more electrodes through a header, a header support that includes one or two openings, and an insulating body that defines a single passage. As an example, FIG. 34 is a cross section of a battery where the case serves as a terminal, a single terminal is in electrical communication with one or more electrodes through the header, a header support 44 includes two openings, and an insulating body 52 defines a single passage. The header support 44 includes two openings. For instance, the header support includes a cathode opening 48 and an electrolyte opening 50 but excludes an anode opening.

The anode tab 36 is in electrical communication with the header support 44. For instance, a weld 70 can connect the anode tab 36 to the header support 44. The header support 44 is in electrical communication with the case 68. For instance, one or more welds 70 can connect the header support 44 to the case 68. As a result, the one or more anodes are in electrical communication with the case 68 through the header support 44. Accordingly, the case 68 can act as a terminal for the battery. In some instances, the anode tab 36 is bent to increase a portion of the anode tab 36 that is parallel or substantially parallel to a surface of the header support 44. As a result, the weld can be positioned between the parallel or substantially parallel regions of the anode tab 36 and the header support 44.

In some instances, the interface between the header support 44 and the case 68 surrounds the header support 44 and any terminals that extend through the header support. For instance, the one or more of the welds 70 can surround the header support 44 and/or extend around the perimeter of the header support 44. As a result, the illustrated battery can have an enhanced resistance to swelling.

The insulating body 52 is positioned above the header support 44 and below the header support 44. In some instances, the insulating body 52 is positioned above and below the header support 44 such that a line can be drawn through the header support 44 and perpendicular to an upper and/or lower surface of the header support 44 with the line extending through the insulating body 52 on opposing sides (i.e. above and below) the header support 44. Additionally, the insulating body 52 is positioned in an interior of the cathode opening 48 such that the portion of the header support 44 defining the cathode opening 48 interior surrounds the portion of insulating body 52 in the interior of the opening. The header support 44 can be partially embedded in the insulating material as is illustrated.

The insulating body 52 defines a cathode passageway 54 that extends through the insulating body 52 from one surface of the insulating body 52 to another opposing surface of the insulating body such as an opposing surface of the insulating body. The cathode tab 10 is positioned in the cathode passageway 54.

FIG. 35 is a cross section of another example of the battery. The case serves as a terminal, a single terminal is in electrical communication with one or more electrodes through the header, the header support 44 includes a single opening, and an insulating body 52 defines a single passage. For instance, the header support includes a cathode opening 48 and excludes an electrolyte opening 50 and an anode opening. A battery precursor can be constructed that includes the header support 44 and insulating body 52 positioned in the case. A liquid electrolyte can be injected into the interior of the case 68 by inserting a needle through the insulating body 52. The electrolyte can flow through a lumen in the needle into the interior of the case 68 before the first case plug 80 is added to the battery precursor. After the needle is withdrawn from the insulating body 52, the first case plug 80 is added to the battery precursor.

The battery is suitable for use in a variety of applications including active implantable medical devices, and commercial applications. Since the battery can be hermetically sealed, the battery is suitable for use in implantable medical devices such as Implantable Cardioverters (pacemakers), Defibrillators (ICDs), implantable cardiac monitors, implantable hearing assist devices, and others.

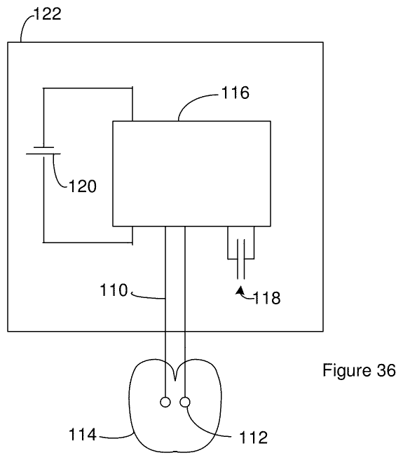

FIG. 36 is a schematic diagram of a defibrillation system that includes an Implantable Cardioverter Defibrillator (ICD) as one example of an active implantable medical device that employs one or more batteries 120 constructed as disclosed above. The defibrillation system includes lead lines 110 connected to electrodes 112 in contact with the heart 114. Although the defibrillation system is shown with two electrodes 112, the defibrillation system may include three or more electrodes 112 and/or three or more lead lines 110. The specific positions of the electrodes 112 relative to the heart 114 is dependent upon the requirements of the patient.

The defibrillation system also includes a processing unit 116. The lead lines 110 provide electrical communication between the processing unit 116 and the electrodes 112. The processing unit 116 is also in electrical communication with one or more capacitors 118.

The processing unit 116 receives power from the battery 120. The processing unit 116 can place the battery 120 in electrical communication with the one or more capacitors 118. For instance, the processing unit 116 can cause the battery 120 to charge the one or more capacitors 118. Additionally, the processing unit 116 can place the one or more capacitors 118 in electrical communication with the lead lines 110. For instance, the processing unit 116 can cause the one or more capacitors 118 to be discharged such that electrical energy stored in the one or more capacitors 118 is delivered to the heart 114 through all or a portion of the electrodes 112. The processing unit 116, the battery 120 and the one or more capacitors 118 are positioned in a case 122.

During operation of the defibrillation system, the defibrillation system employs output from the lead lines 110 to monitor the heart 114 and diagnose when defibrillation shocks should be provided. When the processing unit 116 identifies that defibrillation shocks are needed, the processing unit 116 provides the heart 114 with one or more defibrillation shocks. To provide a defibrillation shock, the processing unit 116 employs energy from the battery 120 to charge the one or more capacitors 118. Once the one or more capacitors 118 are charged, the processing unit 116 causes these capacitors 118 to be discharged such that energy stored in the capacitors 118 is delivered to the heart 114 through all or a portion of the electrodes 112 in the form of defibrillation shocks. During the defibrillation shocks, the defibrillator requires that one or more pulses be delivered from the battery 120 to the one or more capacitors 118. Each pulse is generally associated with a defibrillation shock. The duration of each pulse is generally about 8 to 12 seconds with the pulses separated by a delay time that is based on how fast the battery 120 charges the capacitor 118 and determining the appropriate point to provide the defibrillation shock.

Suitable electronics can include, but are not limited to, analog electrical circuits, digital electrical circuits, processors, microprocessors, digital signal processors (DSPs), computers, microcomputers, or combinations suitable for performing the monitoring and control functions. In some instances, the electronics has access to a memory that includes instructions to be executed by the electronics during performance of the control and monitoring functions.

Although the battery is disclosed as having a cathode between anodes, the battery can be constructed as having an anode between cathodes by changing the material selection for the disclosed cathode to anode materials and changing the material selection for the disclosed anode to cathode materials. Additionally, the battery can be a secondary battery by changing the disclosed cathode materials to positive electrode materials and the disclosed anode materials to negative electrode materials or changing the disclosed cathode materials to negative electrode materials and the disclosed anode materials to positive electrode materials. Though not illustrated, the secondary battery constructions can include cell stacks with either “plate type” or wound (aka “jelly-roll”) architectures. Additionally or alternately, the disclosed electrode assembly can be modified to include only two electrodes or more than three electrodes. The battery is disclosed as having a cathode active medium enclosed within a separator pouch; however, either alternatively or additionally, the anode active medium can be enclosed within a separator pouch.

Additionally or alternately, the disclosed electrode assembly can be modified to include only two electrodes or more than three electrodes

Although the battery is disclosed as having two electrical pathways from the electrode assembly, through the header, to a terminal, the battery can be modified to have a single electrical pathway from the electrode assembly, through the header, to a terminal. For instance, one of the tabs or one of the pins can be electrically connected to the case.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A battery, comprising:
a header positioned at an opening in a case;
an electrode positioned in the case;
a terminal in electrical communication with the electrode through the header; and
a cured epoxy contacting the case and the terminal,
the epoxy sealing the opening in the case, and
the header being between the electrode and the epoxy.

2. The battery of claim 1, wherein the terminal extends outward from the epoxy such that the terminal is in contact with an atmosphere in which the battery is positioned.

3. The battery of claim 1, wherein the epoxy adheres to the terminal and the case such that the epoxy provides a hermetic seal of the opening in the case.

4. The battery of claim 1, wherein the header excludes a glass-to-metal seal.

5. The battery of claim 1, wherein the header includes a header support partially embedded in an insulating body.

6. The battery of claim 5, wherein the insulating body is a single and continuous material, and
the insulating body is positioned above and below the header support such that a line can be drawn through the support and perpendicular to a surface of the header support with the line extending through different portions of the insulating body that are located on opposing sides of the header support

7. The battery of claim 6, wherein the insulating body defines a passage through the insulating body and an electrical pathway between the electrode and the terminal extends through the passage.

8. The battery of claim 7, wherein the header support contacts an interior of the case and the insulating body contacts the header support,
a pin is configured such that a portion of the pin acts as the terminal and the insulating body contacts the pin,
the electrode includes an active medium in contact with an electrode conductor, the electrode conductor includes a current collector and a cathode seat that receives the pin such that the pin is embedded in the active medium, and
the current collector is a continuous material and includes segments that connect to each other at nodes, at least a portion of the segments are curved such that a change in a direction of curvature of the segment occurs at least once along the length of the segment.

9. A battery, comprising:
a header at an opening in a case, the header including a header support partially embedded in an insulating body;
a electrode positioned in the case; and
a terminal in electrical communication with the electrode on an electrical pathway that extends through the header support and through the insulating body.

10. The battery of claim 9, wherein the header support contacts the case.

11. The battery of claim 9, wherein the header support is welded to the case.

12. The battery of claim 9, wherein the header excludes a glass-to-metal seal.

13. The battery of claim 9, wherein the insulating body is a single and continuous material, and
the insulating body is positioned above and below the header support such that a line can be drawn through the support and perpendicular to a surface of the header support with the line extending through different portions of the insulating body that are located on opposing sides of the header support.

14. The battery of claim 13, wherein the insulating body defines a passage through the insulating body and the electrical pathway extends through the passage,
the header support contacts an interior of the case,
a pin is arranged such that a portion of the pin acts as the terminal and the insulating body contacts the pin,
the electrode includes an active medium in contact with an electrode conductor, the electrode conductor includes a current collector and a seat that receives the pin such that the pin is embedded in the active medium.

15. A battery, comprising:
a header at an opening in a case;
a pin extending through the header such that a portion of the pin acts as a battery terminal;
an electrode positioned in the case, the electrode including an active medium in contact with electrode conductor,
the electrode conductor including a current collector and a seat, and
the seat including at least three retainers, the retainers receiving the pin such that a portion of the pin is positioned within the active medium.

16. The battery of claim 15, wherein the retainers are each connected to multiple common supports, a first portion of the retainers extending away from the common supports in a first direction and a second portion of the retainers extending away from the common support in a second direction, the first direction being different from the second direction.

17. The battery of claim 15, wherein the retainers are arranged along a length of the pin such that the retainers included in the first portion of the retainers alternate with retainers included in the second portion of the retainers.

18. The battery of claim 15, wherein the pin can be defined by multiple different three-dimensional wedges that are arranged around a longitudinal axis of the pin and along the longitudinal axis of the pin,
a first portion of the retainers are positioned over a different wedge than a second portion of the retainers.

19. The battery of claim 15, wherein the electrode conductor is a single and continuous piece of material.

20. The battery of claim 15, wherein at least a portion of the retainers each contacts the active medium,
at least a portion of the retainers is each positioned within the active medium, and
the header excludes a glass-to-metal seal.
